(19) United States
(12) Patent Application Publication
(10) Pub. No.: US 2026/0141384 A1
(43) Pub. Date: May 21, 2026

(54) SYSTEM AND METHOD FOR CARDHOLDER INITIATED PRE-AUTHORIZATION

(71) Applicant: Mastercard International Incorporated, Purchase, NY (US)

(72) Inventors: David Vorhies, Saint Charles, MO (US); Christopher T. Scholl, Manchester, MO (US); Shawn Mehrhoff, Sappington, MO (US)

(73) Assignee: Mastercard International Incorporated, Purchase, NY (US)

(21) Appl. No.: 18/955,737

(22) Filed: Nov. 21, 2024

(51) Int. Cl. G06Q 20/40; G06Q 20/28; G06Q 20/32

(52) U.S. Cl. CPC G06Q 20/4014; G06Q 20/28; G06Q 20/3227

(57) ABSTRACT

A computer-implemented method for pre-authorization of funds for future transactions by a user of an electronic mobile device. The method includes receiving a user-selected amount of funds to pre-authorize for a potential upcoming purchase and sending a pre-authorization request for the user-selected amount of funds to an interchange network. The method may also include receiving from the interchange network an authorization of pre-authorized funds and one or more authorization codes associated with the pre-authorized funds, as well as storing an amount of the pre-authorized funds and the authorization codes in memory of the electronic mobile device. Furthermore, the method may include transferring one of the authorization codes to a payment terminal of the merchant in connection with completing the potential upcoming purchase.

### BACKGROUND OF THE INVENTION

Connection problems can occur at any point of sale for any number of reasons, and for merchants using an internet connection or the like to process credit card transactions, current workarounds can lead to loss of profits. For example, if a consumer's credit card account is not in good standing, but the transaction processes because of connectivity issues, then all parties involved must spend resources to fix the bad transaction. This can be common in low dollar transactions in basement vending machines, for example. A $1 transaction can create hundreds of dollars in expenses due to customer service representatives working the case. Merchants may also face issues involving insufficient funds rejections which are not realized until much later when the connection is restored but the customer has already left the store with their purchase.

Thus there is a need for a system that allows for more secure transactions even when the merchant is experiencing connectivity difficulties.

### SUMMARY OF THE INVENTION

Embodiments of the current invention address one or more of the above-mentioned problems and provide a distinct advance in the art of pre-authorization for credit or debit card holders. Some embodiments include a computer-implemented method for pre-authorization of funds for future transactions by a user of an electronic mobile device, including receiving from the user a user-selected amount of funds to pre-authorize for a potential upcoming purchase and sending a pre-authorization request for the user-selected amount of funds to an interchange network. The pre-authorization request includes identification of one or more financial accounts associated with the user for use in the potential upcoming purchase. The method may also include, responsive to the pre-authorization request, receiving from the interchange network an authorization of pre-authorized funds and one or more authorization codes associated with the pre-authorized funds, as well as storing an amount of the pre-authorized funds and the authorization codes in memory of the electronic mobile device. Furthermore, the method may include transferring one of the authorization codes to a payment terminal of the merchant in connection with completing the potential upcoming purchase.

Embodiments of the current invention also include an electronic mobile device for pre-authorization of funds for credit or debit card holders with memory and one or more processors that individually or collectively are programmed to receive from a user a user-selected amount of funds to pre-authorize for a potential upcoming purchase and send a pre-authorization request for the user-selected amount of funds to an interchange network. The pre-authorization request includes identification of one or more financial accounts associated with the user for use in the potential upcoming purchase. The processors are also programmed to, responsive to the pre-authorization request, receive from the interchange network an authorization of the pre-authorized funds and one or more authorization codes associated with the pre-authorized funds, and to securely store an amount of the pre-authorized funds and the authorization codes in encrypted form in the memory of the electronic mobile device. Furthermore, the processors can be programmed to receive a user selection requesting to use at least one of the authorization codes for paying a merchant for a purchase, and to transfer one of the authorization codes to a payment terminal of the merchant in connection with completing the potential upcoming purchase.

In still other embodiments, non-transitory computer-readable storage media having computer-executable instructions for cardholder-initiated pre-authorization of funds for future transactions is disclosed. When executed by at least one processor, the computer-executable instructions cause the at least one processor to receive from a user a user-selected amount of funds to pre-authorize for a potential upcoming purchase and send a pre-authorization request for the user-selected amount of funds to an interchange network. The pre-authorization request includes identification of one or more financial accounts associated with the user for use in the potential upcoming purchase. Furthermore, when executed by the at least one processor, the computer-executable instructions cause the at least one processor to, responsive to the pre-authorization request, receive from the interchange network an authorization of the pre-authorized funds and one or more authorization codes associated with the pre-authorized funds and to encrypt and securely store an amount of the pre-authorized funds and the authorization codes in the memory of the electronic mobile device. Additionally, when executed by the at least one processor, the computer-executable instructions cause the at least one processor to receive a user selection of at least one of the authorization codes for paying a merchant for a purchase and to transfer one of the authorization codes to a payment terminal of the merchant in connection with completing the potential upcoming purchase.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a block diagram of an example payment card network system in which transactions being processed herein can take place in accordance with some embodiments of the technology described herein; and

FIG. 2 is a flow chart of method operations and participating components for cardholder-initiated pre-authorization of funds and uses thereof for future transactions in accordance with some embodiments of the technology described herein.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

A system and method for cardholder-initiated pre-authorization of funds accessed via a credit card, debit card, or an electronic device provides authorization codes for making payments from a user account even when a merchant's payment processing system is down or the merchant is otherwise experiencing connectivity issues. That is, the pre-authorization may be used for future transactions as needed, with or without merchant connectivity (e.g., a functioning internet connection, phone connections, cell phone connections, or the like) at the time of sale and at the point of sale (POS). In some embodiments, a cardholder-initiated pre-authorization process includes an electronic mobile device requesting a user-selected amount of funds to an interchange network (e.g., Mastercard® interchange network or the like) and the interchange network provisioning one or more authorization codes to that electronic mobile device (e.g., a cardholder mobile device like a phone or tablet) for use in one or more future transactions.

In an exemplary embodiment, a payment card network system 10 facilitates providing interchange network services offered by an interchange network 16. In addition, the payment card network system 10 enables payment card transactions in which merchants 12, acquirers 14, and/or issuers 18 do not need to have a one-to-one relationship. Although parts of the payment card network system 10 are presented in one arrangement, other embodiments may include the same or different parts arranged otherwise, depending, for example, on authorization processes for purchase transactions, communication between computing devices, etc.

As used herein, the phrase “payment card network” or “interchange network” (e.g., the interchange network 16) includes a system or network used for the transfer of funds between two or more parties using cash-substitutes. Transactions performed via a payment card network may include, for example, goods and/or service purchases, credit purchases, debit transactions, fund transfers, account withdrawals, and the like. Payment card networks may be configured to perform such transactions using cash-substitutes including, for example, and without limitation, payment cards, checks, financial accounts, and the like. The phrases payment card network and/or interchange network may include the payment card network as an entity, and the physical payment card network, such as the equipment, hardware, and software making up the network. Payment card network or interchange network 16 may also be configured to perform such transactions via phone or smart phone payment apps or the like, such as the electronic mobile device 30 described herein.

In the example embodiment, the payment card network system 10 generally includes the merchants 12, the acquirers 14, the interchange network 16, and the issuers 18, coupled together in communication via a network 20. The network 20 includes, for example and without limitation, one or more of a local area network (LAN), a wide area network (WAN) (e.g., the Internet, etc.), a mobile network, a virtual network, and/or any other suitable public and/or private network capable of facilitating communication among the merchants 12, the acquirers 14, the interchange network 16, and/or the issuers 18. In some embodiments, the network 20 may include more than one type of network, such as a private payment transaction network provided by the interchange network 16 to the acquirers 14 and the issuers 18 and, separately, the public Internet, which may facilitate communication between the merchants 12, the interchange network 16, the acquirers 14, and consumers 22 (also referred to herein as users or cardholders), etc.

Embodiments described herein may relate to a transaction card system, such as a credit card payment system using the Mastercard® interchange network. (Mastercard is a registered trademark of Mastercard International Incorporated.) However, the interchange network 16 can include alternative or additional interchange networks without departing from the scope of the disclosure herein. The Mastercard interchange network is a set of proprietary communications standards promulgated by Mastercard International Incorporated for the exchange of financial transaction data and the settlement of funds between financial institutions that are members of Mastercard International Incorporated. As used herein, financial transaction data can include a unique account number (e.g., a PAN) associated with an account holder or user 22 using a payment card issued by an issuer (e.g., issuer 18), purchase data representing a purchase (e.g., a potential upcoming purchase) made by the user 22, including a type of merchant, amount of purchase, date of purchase, and other data, which may be transmitted between any parties of the system 10. However, in some embodiments, financial transaction data can additionally or alternatively be associated with checks or other digital payment methods (e.g., smart phone apps or apps on the electronic mobile device 30).

In a typical transaction card system, a financial institution called the “issuer” (e.g., card issuer 18) issues a payment card, such as a credit card, to a cardholder or user 22, who uses the payment card to tender payment for a purchase from the merchant 12. In the example embodiment, the merchant 12 is typically associated with products, for example, and without limitation, goods and/or services, that are offered for sale and are sold to the user 22. The merchant 12 includes, for example, a physical location and/or a virtual location. A physical location includes, for example, a brick-and-mortar store, etc., and a virtual location includes, for example, an Internet-based store-front.

To accept payment with the payment card, the merchant 12 may establish an account with the issuing financial institution 18, a merchant bank, or an acquiring bank (also referred to as “the acquirer”) that is part of the payment card network system 10. When the user 22 tenders payment for a purchase with a payment card, the merchant 12 requests authorization for the amount of the purchase from the issuing financial institution 18, a merchant bank, or an acquiring bank. The request may be performed through the use of a POS terminal (also referred to herein as a “payment terminal”) that is an electronic reader device associated with the merchant 12 and configured to read the cardholder's account information from a magnetic stripe, a chip, embossed characters on the payment card, or digital account information from an electronic mobile device 30 (e.g., via Tap and Pay or QR codes using wireless communication devices) and to communicate electronically with the transaction processing computers of the acquirer 14. Alternatively, the acquirer 14 or acquiring bank may authorize a third party to perform transaction processing on its behalf. In this case, the POS terminal will be configured to communicate with the third party. Such a third party is usually called a “merchant processor,” an “acquiring processor,” or a “third party processor.” In some embodiments, the POS terminal or payment terminal may be a merit-based incentive payment system (MIPS), a web portal payment system or cart, or the like.

Using the interchange network 16, computers of the acquirer 14 or a merchant processor will communicate with computers of the issuer 18 to determine whether the cardholder's account is in good standing and whether the purchase is covered by the cardholder's available credit line. Based on these determinations, the request for authorization will be declined or accepted. If the request is accepted, an authorization code is issued to the merchant 12.

However, it should be noted here that in methods described herein, the POS terminal may experience connectivity issues and inability to directly communicate with the acquirer, the issuer, and/or the interchange network 16, in which case one or more authorization codes may be issued directly to the user 22 via the electronic mobile device 30 associated with the user 22, to later be provided to the merchant 12 and/or the POS terminal associated with the merchant 12 for the purchase, as discussed in more detail below.

When a typical request for authorization is accepted, the available credit line of the cardholder's account is decreased. Normally, a charge for a payment card transaction is not posted immediately to the cardholder's account because bankcard associations, such as Mastercard, have promulgated rules that do not allow the merchant 12 to charge, or “capture,” a transaction until the purchased goods are shipped or the purchased services are delivered. However, with respect to at least some debit card transactions, a charge may be posted at the time of the transaction. When the merchant 12 ships or delivers the goods or services, the merchant 12 captures the transaction by, for example, appropriate data entry procedures on the point-of-sale terminal. This may include bundling of approved transactions daily for standard retail purchases. If the cardholder or user 22 cancels a transaction before it is captured, a “void” is generated. If the cardholder or user 22 returns goods after the transaction has been captured, a “credit” is generated. The interchange network 16 and/or the issuer 18 stores the payment card information, such as, and without limitation, a type of merchant, a merchant identifier, a location where the transaction was completed, an amount of purchase, and a date and time of the transaction, in a transaction database 24.

After a purchase has been made, a clearing process occurs to transfer additional transaction data related to the purchase among the parties to the transaction. More specifically, during and/or after the clearing process, additional data, such as a time of purchase, a merchant name, a type of merchant, purchase information, cardholder account information, a type of transaction, itinerary information, information regarding the purchased item and/or service, and/or other suitable information, is associated with a transaction and transmitted between parties to the transaction as transaction data, and may be stored by any of the parties to the transaction.

After a transaction is authorized and cleared, the transaction is settled among the parties. Settlement refers to the transfer of financial data or funds among the merchant 12, the issuing financial institution 18, or other parties related to the transaction as described above. Usually, transactions are captured and accumulated into a “batch,” which is settled as a group. More specifically, a transaction is typically settled between the issuer 18 and the interchange network 16, then between the interchange network 16 and the acquirer 14, and then between the acquirer 14 and the merchant 12.

In some embodiments, the payment card transaction is a card present transaction conducted, for example, by swiping or dipping a payment card at the merchant's POS terminal, or alternatively via the electronic mobile device 30 communicating with the POS terminal. Alternatively, the payment card transaction may be a card-not-present transaction conducted, for example, with a payment card stored on file with the merchant 12 or stored as digital wallet data in an electronic wallet on a consumer's computing device or the electronic mobile device 30. The interchange network 16 includes an authentication system 26 that is configured to analyze various data associated with the payment card transaction and provide various information to one or more parties involved in the payment card transaction, such as the merchant 12 and the acquirer. However, the authentication system 26 can be omitted or replaced without departing from the scope of the technology herein. Alternatively, in some embodiments, the authentication system 26 can perform one or more of the method operations described herein.

Each of the acquirer 14, the interchange network 16, and/or the issuer 18 may use a variety of systems, servers, or the like to receive requests from the electronic mobile device 30, send authorization codes in response thereto, and otherwise perform operations attributable respectively thereto in this disclosure. The systems or servers may include processors or processing devices, memory, databases, communication components, and various hardware or software for executing one or more of the method operations described herein.

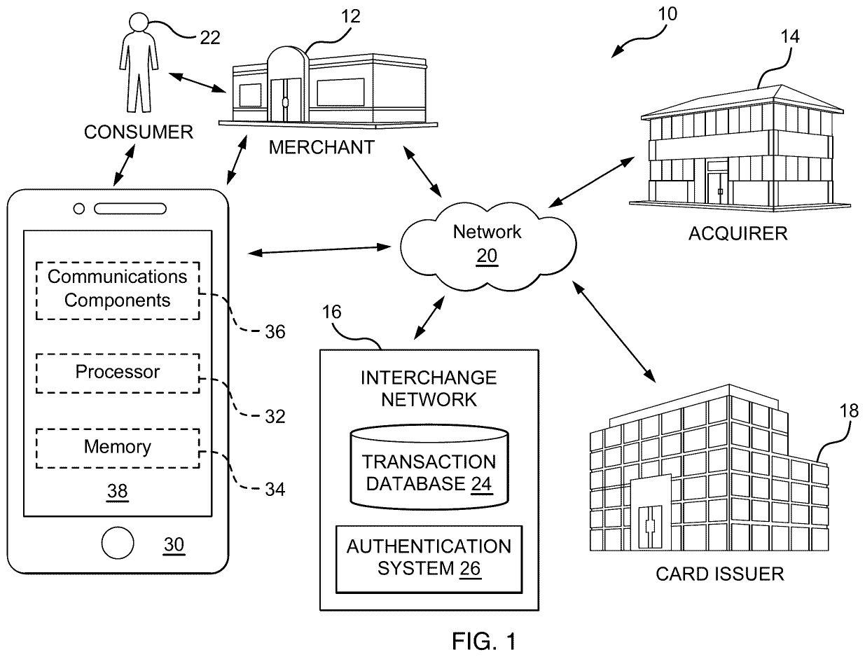

As depicted in FIG. 1, the electronic mobile device 30 may include at least one processor 32, memory 34, communications components 36, and a user interface 38. The electronic mobile device 30 may be, for example, a cellular telephone, a smart watch or other electronic wearable apparel, a tablet, an implanted smart device, a personal computing device, or any other electronic device capable of two-way digital communications which may be associated with a cardholder or the user 22 for performing one or more of the methods described herein. In some embodiments, the electronic mobile device 30 may be replaced with another computing device suitable for performing the functions disclosed herein (e.g., a desktop or laptop computer, a smart television, etc.). The electronic mobile device 30 may be configured to perform financial transactions of the cardholder, for example, via a user mobile application (also referred to herein as an “app”) running on the electronic mobile device 30.

The processor 32 and any other processors described or referenced herein may include one or more processing elements or processors (e.g., digital processing unit(s)) physically coupled within the electronic mobile device 30 and/or one or more processing elements or processors communicably coupled as part of a cloud-based or virtual network of processors, some located on the electronic mobile device 30 and others located remotely therefrom. In some example embodiments, the processor 32 or its processing elements may comprise dedicated circuitry or logic that is permanently configured, such as an application-specific integrated circuit (ASIC), or indefinitely configured, such as an FPGA, to perform certain operations. The processor 32 or processing elements may also comprise programmable logic or circuitry (e.g., as encompassed within a general-purpose processor or other programmable processor) that is temporarily configured by software, software applications, or apps to perform certain operations as later described herein.

The memory 34 and any other memories described or referenced herein can include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

The processor 32 is operatively coupled to the communications components 36, and other paired processors and communications components described or referenced herein might be similarly coupled, such that the merchant 12, acquirer 14, the interchange network 16, and/or the issuer 18 or systems and servers thereof can communicate one with another and with the electronic mobile device 30. The communication components 36 and other communication components described or referenced herein may include wireless antennas for mobile phone or cell phone network communications, Bluetooth, Wi-Fi, or other wireless communication components, and/or may include wired communications components capable of providing Internet connections or communication connections via other electronic or digital communication systems. In some embodiments, the communications components 36 may receive information or data from the processor 32 and/or the memory 34 of the electronic mobile device 30 and transmit that information or data to processors or servers of the acquirer 14, the interchange network 16, the issuer 18, and/or a payment terminal of the merchant 14, as later described herein.

The user interface 38 includes one or more user interfaces for sending and/or receiving information between the electronic mobile device 30 and the user 22 or cardholder. The user interface 38 may include, for example, display screens, touch screens, keypads, microphones, speakers, keyboards, a computer mouse or trackball, other display and/or user input devices. In some embodiments, the processor 32 may send and receive communications to and from user interfaces, such that information can be shared with the user 22 or cardholder and can be received from the user 22 or cardholder. For example, the user 22 or cardholder can select an app or software program via a touchscreen on a mobile phone to request pre-authorized funds and authorization codes associated therewith, as described herein.

Various example-use cases for the system and method described herein are provided below. For example, the method may begin with the user 22 (also referred to herein as a cardholder) opening a banking/credit app or software application on the electronic mobile device 30. Within the app, the user 22 can select an amount of funds to pre-authorize for a potential upcoming purchase. For example, the app may provide user-selectable buttons or input displayed for the user 22 to select a total amount (e.g., the total pre-authorized funds) to be associated with one or more authorization codes to be received during the method described herein. Receiving multiple authorization codes allows for multiple purchases to be made using the authorized funds, since each of the authorization codes may generally only be used once.

The precise amount out of the total of the pre-authorized funds that is associated with each of the authorization codes is determined based on what purchase price is approved by the user at the payment terminal or at the merchant during a future purchase. Specifically, a plurality of authorization codes may be issued along with one total pre-authorized fund amount, and different ones of the authorization codes will be used for each separate purchase, in each case such that the used authorization code then becomes directly associated with the purchase price which is therefore deducted from the total amount of pre-authorized funds stored in the memory 34 of the electronic mobile device 30, and further such that a reduced amount of pre-authorized funds is then available for future purchases.

The issuing financial institution 18 may perform an authorization of the requested fund amount in a same manner as an authorization request received across the interchange network 16 during a typical sale requested by the merchant 12. Based on the authorization approval from the financial institution or issuer 18, the interchange network 16 generates and provisions a user-requested or preset number of authorization codes (e.g., one (1) authorization code, five (5) different authorization codes, etc.). In one or more embodiments, the issuing financial institution 18 only issues an approval or authorization, and consequently the interchange network 16 only provides these authorization codes, if there is a determination made that the cardholder's account is in good standing and the requested amount is covered by the cardholder's available credit line (e.g., determined via the issuer 18). In some embodiments, the electronic mobile device 30 receives from the interchange network 16 an authorization of pre-authorized funds equal to or less than the user-selected amount of funds and one or more authorization codes associated with the pre-authorized funds. For example, in instances where less than the requested funds are available in the user's account, the user and/or user settings can allow for an amount less than the requested funds to be pre-authorized. Details of the authorization can be encrypted by the interchange network 16 and/or electronic mobile device 30 and stored in secure storage on the electronic mobile device 30 once received thereby and may remain there until the user 22 elects to use one of the authorization codes for a purchase as further described below.

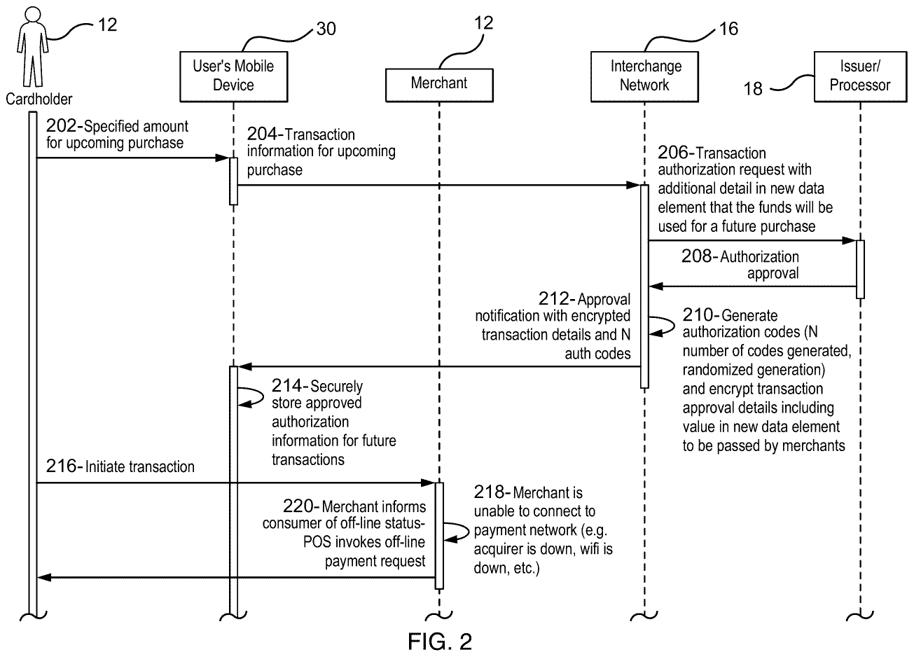

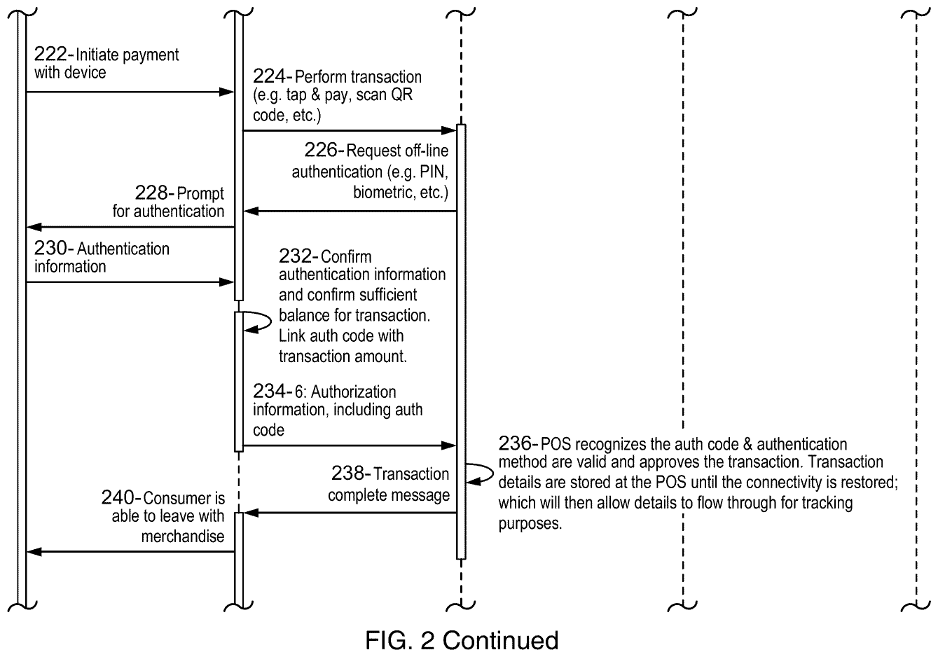

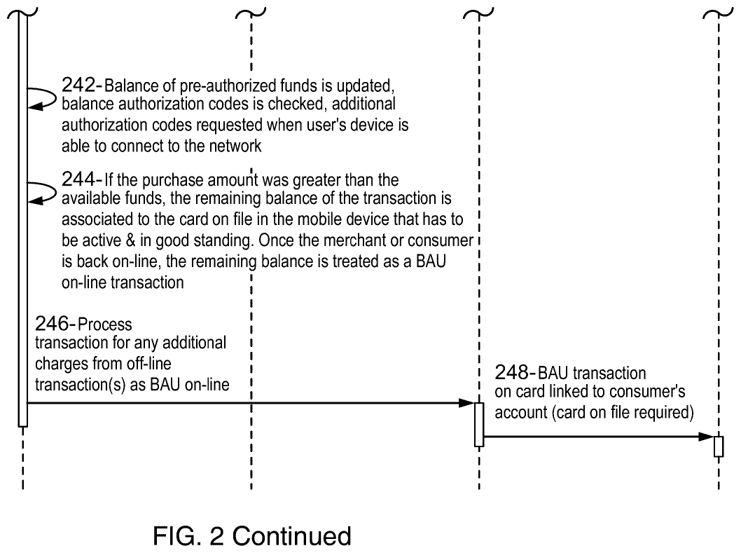

Method operations for an exemplary method of requesting, obtaining, and utilizing pre-authorized funds and authorization codes to pay for purchases when connectivity issues prevent traditional credit or debit card payments to be processed by the merchant 12 will now be described in more detail, in accordance with various embodiments of the present invention. The operations of method 200 may be performed in the order as shown in FIG. 2, or they may be performed in a different order. Furthermore, some operations may be performed concurrently as opposed to sequentially. In addition, some operations may not be performed.

Specifically, the flow chart in FIG. 2 depicts the various data communicated between the various devices and participants in a transaction when using the pre-authorized codes as described above. For example, the method 200 may include the electronic mobile device 30 receiving, from the user 22 or cardholder, a user selection via the app, with that user selection indicating a request for a specified amount of funds for an upcoming purchase, as depicted at 202. The method 200 may further include the electronic mobile device 30 transmitting transaction information for the upcoming purchase, along with or comprising a request for pre-authorization for the selected or specified amount, to the interchange network 16, as depicted at 204.

As described above, the interchange network 16 may include one or more systems, networks, servers, and/or processors, and the issuer 18 may also include one or more systems, networks, servers, and/or processors. In each case such components may be constructed and/or may comprise components discussed in more detail above in connection with the construction of the device 30.

In the example method 200 depicted in FIG. 2, the interchange network 16, in response to receiving the transaction information for the upcoming purchase (e.g., the request for pre-authorization), may send a transaction authorization request to the issuer 18, as depicted at 206, along with or including details indicating that the funds will be used for a future purchase, and the issuer 18 may send an authorization approval back to the interchange network 16 if sufficient funds are available in an account associated with the user 22, as depicted at 208. Upon receiving this authorization approval, the interchange network 16 may generate authorization codes (and, optionally, encrypt the authorization codes and/or transaction approval details), as depicted in 210. For example, N number of codes may be generated via randomized generation. The encrypted transaction approval details may include a value in a new data element (relative, for example, to existing payment card industry standard data fields) to be passed by the merchant 12 during the future transaction using one or more of the authorization codes. The authorization codes may be securely stored in the memory 34 of the electronic mobile device 30. In some embodiments, the authorization codes and/or transaction approval details (such as a pre-authorized funds amount) may be encrypted via the electronic mobile device 30 upon receipt thereby prior to being stored in the memory 34 thereof. Note that in some embodiments, some or all of the method operations depicted in 206-210 may be performed by a single system, a single bank, or by a single issuing financial institution without departing from the scope of the disclosure herein. Additionally or alternatively, other intermediary systems (e.g., the interchange network 16 or others) may perform or be associated with one or more of the method operations depicted in 206-210 without departing from the scope of the disclosure herein.

The method 200 may further include the electronic mobile device 30 receiving from the interchange network 16 an approval notification with encrypted transaction details and one or more authorization codes, as depicted at 212, and securely storing the approved authorization information (e.g., total amount of pre-authorized funds) and the one or more authorization codes for future transactions, as depicted at 214.

The method 200 in FIG. 2 further comprises an operation of the cardholder or user 22 initiating a transaction with the merchant 12 using the electronic mobile device 30 and/or the cardholder's credit or debit card associated with one of their financial accounts, as depicted at 216, and the merchant 12 being unable to connect to a payment network, as depicted at 218. For example, connectivity issues may exist such as Wi-ﬁ being down, an acquirer being down, or other known issues that interfere with electronic transactions at a POS. The merchant 12 then informs the user 22 or cardholder of these connectivity issues (e.g., off-line status), as depicted at 220, and requests an offline payment.

In response to the connectivity issues described above, the method 200 then may include the cardholder or user 22 initiating payment with the electronic mobile device 30, as depicted at 222, and the electronic mobile device 30 transmitting information to the merchant's POS terminal or payment terminal, as depicted at 224. In one or more embodiments, the user 22 may use Tap and Pay, scanning of a QR code, or the like, to transmit the information to the payment terminal (e.g., transaction information and authorization codes) as depicted at 224. In some embodiments, when the user 22 is checking out with the merchant 12 pursuant to steps 222 et seq., he or she can select to use one or any of the stored authorization codes from menu options displayed via the app on the electronic mobile device 30, whether or not there is a situation where the merchant 12 indicates connectivity issues would otherwise prevent the user 22 from being able to make the purchase by card.

The method 200 may further include the electronic mobile device 30 receiving from the POS device a request for off-line authentication, as depicted at 226. This may cause the electronic mobile device 30 to prompt the cardholder or user 22 for authentication or off-line authentication, for example, a PIN, biometric request, or the like, as depicted at 228. The method 200 may then include the electronic mobile device 30 receiving authentication information from the cardholder or user 22, as depicted at 230. In response to receiving the authentication information from the cardholder or user 22, the method 200 may include the electronic mobile device 30 confirming the authentication information and sufficient balance for transaction, as well as linking one of the authorization codes with the transaction amount and transaction, as depicted at 232. The one of the authorization codes may be one of the authorization codes pre-authorized in operations 202 through 212. When the user's electronic mobile device 30 is used for Tap and Pay or QR scan, for example, one of the authorization codes can then be transferred via the electronic mobile device 30 to the merchant POS terminal or payment terminal for association with the transaction and the purchase price total (include tax, tip, and/or any other additional incidentals approved by the user s2) and completion of the purchase.

The method 200 may then include sending with the electronic mobile device 30 authorization information, including the authorization code linked with the transaction balance, as depicted at 234. If the POS terminal or payment device recognizes the authorization code and that the authentication method are valid, it approves the transaction, as depicted at 236. The transaction details may be stored at the POS device until the connectivity is restored, which will then allow the details to flow through to the interchange network 16 and/or the issuer 18 for tracking purposes. The method 200 may also include a transaction complete message or indicator being received by the electronic mobile device 30, as depicted at 238, and the consumer is able to leave with the merchandise, as depicted at 240.

In the case of a connectivity issue experienced by the merchant 12 or the payment terminal, such as internet or other various systems going down at the POS, the merchant 12 can store the authorization code via the payment terminal, along with the purchase price, and have confidence in proceeding with the transaction, as the user 22 was previously approved for the funds required for the purchase. The authorization code used for the purchase also becomes directly associated with the purchase price, which is deducted from the total amount of pre-authorized funds remaining, as stored on the electronic mobile device 30.

If the purchase is less than the pre-authorized amount, the electronic mobile device 30 automatically splits the pre-authorized funds, with one code now being associated with the purchase price and the pre-authorized amount reduced by that purchase price and available for use with remaining ones of the authorization codes for other future purchases. For example, transferring one of the authorization codes to the payment terminal of the merchant, may indicate approval by the issuing financial institution of an amount sufficient to cover all of a price total for the purchase.

When the user 22 exhausts all of the authorization codes, he or she will need to re-establish connectivity to the interchange network 16 and/or the issuer 18 to refresh the codes (e.g., obtain new codes that can be associated with any remaining pre-authorized funds or with new funds requested by the user 22). For example, in some embodiments, as depicted at 242, the method 200 may also include updating the balance of the pre-authorized funds, checking the balance authorization codes, requesting additional authorization codes when the electronic mobile device 30 is able to connect to the network of the interchange network 16 and/or the issuer 18 (e.g., when Wi-Fi signal is restored). In some embodiments, the authorization codes can also be refreshed without user interaction, such as automatically upon re-established connectivity based on settings in the app (e.g., if the user requests new codes as long as there are pre-authorized funds remaining or requests that pre-authorized funds and/or new codes are automatically requested if the pre-authorized funds fall below a certain dollar amount).

In some embodiments, the method 200 may include contingent options if the purchase amount was greater than the available pre-authorized funds associated with the authorization codes, as depicted at 244. For example, transferring one of the authorization codes to the payment terminal of the merchant when not enough remains in the pre-authorized funds may result in an indication to the payment terminal/merchant that approval by the issuing financial institution will only cover a portion of a price total for the purchase. This may occur when a purchase requires more than the user 22 budgeted for or when additional items were added to the expected purchase. In one or more example embodiments, the remaining balance of the transaction (the full amount due minus the pre-authorized amount associated with the authorization code or codes) can be associated with a card on file with the merchant 12 and/or in the electronic mobile device 30 that is active and in good standing, such that once the merchant 12 or consumer is back online, the remaining balance of the transaction is treated as a business as usual (BAU) online transaction between the merchant 12 and the acquirer 14, the interchange network 16, and/or the issuer 18, as depicted in 246 and 248. This allows the merchant 12 having connectivity issues to still make a sale while a connection is down and to be reassured that at least some of the funds were already pre-authorized. Were this not the case, when the merchant 12 accepts credit card information and runs the card later after connectivity is restored but the customer has already left, the merchant 12 would typically be out the entire purchase price of the product if the card is then declined for insufficient funds or the like. Thus, the present technology described herein advantageously allows for transactions to securely continue electronically without the need for cash or physical currency even with there are connectivity issues experienced by a merchant.

In some embodiments, the merchant may configure thresholds and various rules for the payment terminal or systems associated therewith such that this type of offline transaction is only accepted under certain thresholds or under certain circumstances. For example, the merchant may require that the pre-authorized funds cover at least a certain percentage (e.g., 70%) of the full purchase price for completion of the transaction. In yet another example, if the purchaser/user has a card on file with the merchant that was recently updated (within a set period of time), such as where both the user and the merchant are enrolled in Automatic Billing Updater (ABU) or the like and the user's credit card expiration date was recently updated and/or other data indicates that the credit card was in good standing prior to the merchant losing connectivity, the merchant may automatically accept the pre-authorized funds that cover only a portion of the purchase price. Then, with the user's authorization to run the card on file for a remainder of the purchase price, the merchant can receive the remainder of the purchase price once connectivity is restored. Although two different authorization codes are used for these types of transactions, the transactions performed in this manner may be linked automatically by one or more of the systems or networks described herein once connection is restored, so that a single transaction appears on statements issued to the user 22.

In some embodiments, the electronic mobile device 30 (e.g., via a financial app thereon) may sync with the interchange network 16 and/or the issuer 18 once connectivity is restored. Furthermore, the electronic mobile device 30 may send a request to the interchange network 16 to cancel any unused ones of the authorization codes and release any remaining unspent amount of the pre-authorized funds based on input received from the user. For example, the user may change user settings in the app or software application to return any of the pre-authorized funds to their original account and/or to cancel the authorization codes associated therewith immediately upon again being connected to the interchange network 16 and/or the issuer 18, after a pre-determined amount of time (e.g., a number of days or a date for the authorization codes to expire), or based on a pre-established condition set by the user (e.g., if the user's account funds fall below a particular threshold).

In one or more embodiments, pre-authorized funds can also be used during an eCommerce transaction via a push authentication to the app on the user' electronic mobile device 30. For example, the user 22 may be prompted via the push authentication request asking if the transaction should be completed using one of the authorization codes and pre-authorized funds, and the user 22 can select “no” or “yes”, or can select a specific one of the authorization codes to be used for that eCommerce transaction. This eCommerce transaction can be used along with these pre-authorized funds on location at a merchant store if the system goes down and the user wishes to still purchase the item in the store. Location-based information from the electronic mobile device 30 may also allow for such a purchase to be credited as an in-store purchase from that store.

Additionally, in one or more embodiments, the user 22 can elect to use the pre-authorized authorization codes to unlock certain perks through the interchange network 16, the issuer 18, and/or another third-party affiliate (e.g., pre-authorization of $900 discretely passed to a merchant upon arrival may instantly move the user into a VIP/bottle service area). This allows the user to impress guests without having a prior relationship with the merchant (e.g., the restaurant or club). Furthermore, in some embodiments, users may utilize the system and methods disclosed herein as a smart budgeting tool. Absent minded or busy entrepreneurs or customers can, for example, authorize an amount of an important charge coming up. This will lock those funds, also preventing an insufficient funds charge from interrupting other important items (e.g., daycare, rent, etc.).

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor (e.g., the processor 22) or processing element, may be implemented as special purpose or as general purpose. In some embodiments, the processor or processing element is a component of the electronic mobile device 30. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processor”, “processing element”, or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communications components, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processor-implemented or processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server or a collection of servers such as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112(f) unless traditional means-plus-function language is expressly recited, such as “means for” or “operation for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A computer-implemented method for pre-authorization of funds for future transactions by a user of an electronic mobile device, the method comprising:
receiving from the user a user-selected amount of funds to pre-authorize for a potential upcoming purchase;
sending a pre-authorization request for the user-selected amount of funds to an interchange network, the pre-authorization request including identification of one or more financial accounts associated with the user for use in the potential upcoming purchase;
responsive to the pre-authorization request, receiving from the interchange network an authorization of pre-authorized funds and one or more authorization codes associated with the pre-authorized funds;
storing an amount of the pre-authorized funds and the one or more authorization codes in memory of the electronic mobile device; and
completing a transaction with a payment terminal while the payment terminal is offline or experiencing connectivity problems by transferring one of the one or more authorization codes via the electronic user device to the payment terminal of a merchant to be stored by the payment terminal, wherein the one of the one or more authorization codes is configured to be recognizable by the payment terminal as valid without connectivity between the payment terminal and the interchange network.

2. The computer-implemented method of claim 1, wherein the one or more authorization codes are encrypted and securely stored in the memory of the electronic mobile device.

3. The computer-implemented method of claim 1, further comprising storing a remaining amount of the pre-authorized funds in the electronic mobile device in response to the transferring of the one of the one or more authorization codes to the payment terminal of the merchant, wherein the remaining amount of the pre-authorized funds is the amount of the pre-authorized funds minus a price total for the completed purchase.

4. The computer-implemented method of claim 1, further comprise splitting the amount of the pre-authorized funds between at least two purchases and at least two of the one or more authorization codes if a price total for the purchase is less than the amount of the pre-authorized funds.

5. The computer-implemented method of claim 1, further comprising receiving additional authorization codes and associating the additional authorization codes with the pre-authorized funds or a portion remaining of the pre-authorized funds upon re-established connectivity in response to the one or more authorization codes being exhausted while at least a portion of the pre-authorized funds are not yet exhausted.

6. The computer-implemented method of claim 1, further comprising determining that a price total for the potential upcoming purchase is greater than a remaining amount of the pre-authorized funds and sending a request to the payment terminal requesting that the remaining amount of the pre-authorized funds be used for a portion of the price total of the potential upcoming purchase and that a remainder of the price total for the potential upcoming purchase be charged to a card on file once connectivity is restored to the payment terminal.

7. The computer-implemented method of claim 1, further comprising:
transferring all of a remaining amount of the pre-authorized funds along with at least one of the one or more authorization codes to the payment terminal of the merchant if a price total for the potential upcoming purchase is greater than the remaining amount of the pre-authorized funds; and
providing financial account information and user approval to the payment terminal of the merchant indicating approval to process a remaining balance of the purchase using the financial account information once connectivity is restored to the payment terminal.

8. The computer-implemented method of claim 1, further comprising sending a request to the interchange network to cancel any unused ones of the one or more authorization codes following completion of the purchase and release any remaining unspent amount of the pre-authorized funds based on input received from the user.

9. An electronic mobile device for pre-authorization of funds for credit or debit card holders, the electronic mobile device comprising memory and one or more processors configured to individually or collectively programmed to:
receive from a user a user-selected amount of funds to pre-authorize for a potential upcoming purchase,
send a pre-authorization request for the user-selected amount of funds to an interchange network, the pre-authorization request including identification of one or more financial accounts associated with the user for use in the potential upcoming purchase,
responsive to the pre-authorization request, receive from the interchange network an authorization of the pre-authorized funds and one or more authorization codes associated with the pre-authorized funds;
securely store an amount of the pre-authorized funds and the one or more authorization codes in encrypted form in the memory of the electronic mobile device,
receive a user selection requesting to use at least one of the one or more authorization codes for paying a merchant for a purchase; and
complete a transaction with a payment terminal while the payment terminal is offline or experiencing connectivity problems by the transfer of one of the one or more authorization codes via the electronic mobile device to a payment terminal of the merchant to be stored by the payment terminal, wherein the one of the one or more authorization codes is configured to be recognizable by the payment terminal as valid without connectivity between the payment terminal and the interchange network.

10. The electronic mobile device of claim 9, wherein the one or more processors are further configured to store a remaining amount of the pre-authorized funds in the electronic mobile device in response to the transfer of the one of the one or more authorization codes to the payment terminal of the merchant, wherein the remaining amount of the pre-authorized funds is the amount of the pre-authorized funds minus a price total for the completed purchase.

11. The electronic mobile device of claim 9, wherein the one or more processors are further configured to split the amount of the pre-authorized funds between at least two purchases and at least two of the one or more authorization codes if a price total for the purchase is less than the amount of the pre-authorized funds.

12. The electronic mobile device of claim 9, wherein the one or more processors are further configured to receive additional authorization codes and associate the additional authorization codes with the pre-authorized funds or a portion remaining of the pre-authorized funds upon re-established connectivity in response to the one or more authorization codes being exhausted while at least a portion of the pre-authorized funds are not yet exhausted.

13. The electronic mobile device of claim 9, wherein the one or more processors are further configured to determine that a price total for the potential upcoming purchase is greater than a remaining amount of the pre-authorized funds and send a request to the payment terminal requesting that the remaining amount of the pre-authorized funds be used for a portion of the price total of the potential upcoming purchase and that a remainder of the price total for the potential upcoming purchase be charged to a card on file once connectivity is restored to the payment terminal.

14. The electronic mobile device of claim 9, wherein the one or more processors are further configured to:
transfer all of a remaining amount of the pre-authorized funds along with at least one of the one or more authorization codes to the payment terminal of the merchant if a price total for the potential upcoming purchase is greater than the remaining amount of the pre-authorized funds; and
provide financial account information and user approval to the payment terminal of the merchant indicating approval to process a remaining balance of the purchase using the financial account information once connectivity is restored to the payment terminal.

15. Non-transitory computer-readable storage media having computer-executable instructions for cardholder-initiated pre-authorization of funds for future transactions via an electronic mobile device, wherein when executed by at least one processor, the computer-executable instructions cause the at least one processor to:
receive from a user a user-selected amount of funds to pre-authorize for a potential upcoming purchase,
send a pre-authorization request for the user-selected amount of funds to an interchange network, the pre-authorization request including identification of one or more financial accounts associated with the user for use in the potential upcoming purchase,
responsive to the pre-authorization request, receive from the interchange network an authorization of the pre-authorized funds and one or more authorization codes associated with the pre-authorized funds;
securely store an amount of the pre-authorized funds and the one or more authorization codes in the memory of the electronic mobile device,
receive a user selection of at least one of the one or more authorization codes for paying a merchant for a purchase; and
complete a transaction with a payment terminal while the payment terminal is offline or experiencing connectivity problems by the transfer of one of the one or more authorization codes via the electronic mobile device to a payment terminal of the merchant to be stored by the payment terminal, wherein the one of the one or more authorization codes is configured to be recognizable by the payment terminal as valid without connectivity between the payment terminal and the interchange network.

16. The non-transitory computer-readable storage media of claim 15, wherein the computer-executable instructions further cause the at least one processor to store a remaining amount of the pre-authorized funds in the electronic mobile device in response to the transfer of the one of the one or more authorization codes to the payment terminal of the merchant, wherein the remaining amount of the pre-authorized funds is the amount of the pre-authorized funds minus a price total for the purchase.

17. The non-transitory computer-readable storage media of claim 15, wherein the computer-executable instructions further cause the at least one processor to split the amount of the pre-authorized funds between at least two purchases and at least two of the one or more authorization codes if a price total for the purchase is less than the amount of the pre-authorized funds.

18. The non-transitory computer-readable storage media of claim 15, wherein the computer-executable instructions further cause the at least one processor to receive additional authorization codes and associate the additional authorization codes with the pre-authorized funds or a portion remaining of the pre-authorized funds upon re-established connectivity in response to the one or more authorization codes being exhausted while at least a portion of the pre-authorized funds are not yet exhausted.

19. The non-transitory computer-readable storage media of claim 15, wherein the computer-executable instructions further cause the at least one processor to determine that a price total for the potential upcoming purchase is greater than a remaining amount of the pre-authorized funds and send a request to the payment terminal requesting that the remaining amount of the pre-authorized funds be used for a portion of the price total of the potential upcoming purchase and that a remainder of the price total for the potential upcoming purchase be charged to a card on file once connectivity is restored to the payment terminal.

20. The non-transitory computer-readable storage media of claim 15, wherein the computer-executable instructions further cause the at least one processor to:
transfer all of a remaining amount of the pre-authorized funds along with at least one of the one or more authorization codes to the payment terminal of the merchant if a price total for the potential upcoming purchase is greater than the remaining amount of the pre-authorized funds; and
provide financial account information and user approval to the payment terminal of the merchant indicating approval to process a remaining balance of the purchase using the financial account information once connectivity is restored to the payment terminal.
